(19) United States
(12) Patent Application Publication
(10) Pub. No.: US 2023/0324080 A1
(43) Pub. Date: Oct. 12, 2023

(54) HEATING SYSTEM AND RELATED METHODS

(71) Applicant: Teana LLC, Dover, DE (US)

(72) Inventors: Alejandro Rivera, Dover, DE (US); Jairo Montes, Dover, DE (US); Laura Montoya, Dover, DE (US)

(21) Appl. No.: 18/131,467

(22) Filed: Apr. 6, 2023

Related U.S. Application Data
(60) Provisional application No. 63/329,069, filed on Apr. 8, 2022.

(51) Int. Cl. F24H 15/16; F24H 1/20; F24H 15/37; F24H 15/223

(52) U.S. Cl. CPC F24H 15/16; F24H 1/201; F24H 15/37; F24H 15/223

(57) ABSTRACT

A water-heating system includes a water reservoir having a storage tank adapted to hold water to be heated, an AC-powered heating element arranged to heat water in the storage tank when coupled electrically to an alternating current, and a DC-powered heating element arranged to heat water in the storage tank when coupled electrically to a direct current.

### CROSS-REFERENCE TO RELATED APPLICATIONS

This application claims priority to U.S. Provisional Application No. 63/329,069, filed on Apr. 8, 2022, the disclosure of which is hereby incorporated by reference herein in its entirety.

### FIELD OF THE DISCLOSURE

The present disclosure relates generally to water-heating systems, and more specifically to water-heating systems adapted to selectively heat water using renewable energy.

### BACKGROUND

Renewable energy is a sustainable form of energy that comes from sources that are present naturally in our ecosystem and have the potential of providing us with endless energy supply, however, they are limited in the amount of energy that is available at a given moment. This availability depends on certain factors specific to each type of renewable energy. For example, one of the most abundant and freely available energy sources comes from the sun. The amount of solar energy that reaches the earth's surface in one hour would be enough to power the world's needs for a year. But this is not that simple, the amount of solar energy we can use varies according to the time of day, the season of the year and the geographical location.

Domestic renewable energy systems are becoming more and more common every day to increase the overall energy efficiency, reduce energy bills and CO₂ emissions. These systems can be connected to work in two different modes, grid-connected or stand-alone. A Grid-connected system allows the user to sell any excess power not used inside the home, back to the power provider (utility). In order to do so, grid-connected systems need, beside the components of the renewable system, additional equipment to safely transmit electricity to the home and at the same time comply with the power provider's grid-connection requirements. This type of equipment may include power conditioning and safety, meters and instrumentation. Since this are grid-integrated systems, they work in AC at constant voltage that is the same of the power provider, usually 110V-220V. On the other hand, stand-alone systems work completely off-grid, in some cases for homes in remote areas, being the sole source of power. This type of system is more complex than a grid-connected system as it requires batteries and charge controller equipment in top of all the other equipment. Stand-alone systems are also usually setup to work in AC as the great majority of household appliances work on AC. But there is also the option to use the DC power directly from the system for special applications.

A great amount of the capital cost of renewable energy systems comes from the energy storage equipment (batteries and charge controllers), which is one of the main reasons why most systems don't have storage or are a drawback from installing a renewable energy system in the first place. One way in which these systems could be simplified and costs reduced, is to use thermal energy storage systems (TES) instead of electric batteries. Saving the energy surplus for later use can help maximize self-consumption in cases where electric batteries are not available, and help save money, since the selling price of a kWh to the power provider is generally less than the cost of buying a kWh from them. So instead of selling at low rates, customers could store even more energy in the form of heat with a TES system. A common way to have a TES system is to use water as a medium to store energy in the form of heat. A water-based TES system could provide hot water for space heating, domestic hot water consumption or a combination of both. A TES system like this could also be used for space cooling and other applications.

In order to integrate TES with renewable energy systems, several factors need to be taken into consideration, such as the working voltage and current type (AC or DC) of the renewable energy system. As not every customer has the same conditions in terms of power resources, it would be desirable that the water-heating system has the ability of being installed and operate under any circumstances without the need for special configurations or adaptations. At the same time, as conditions might change, for example, with customers shifting from a 100% utility power supply to a situation with partial power being supplied by a simple DC renewable power source, and then to a grid-connected AC renewable system, it would be important that the system could be automatically adapted to those changes, which is not usually the case since different configurations require specific electrical equipment or appliances to work with.

### SUMMARY

The present disclosure may comprise one or more of the following features and combinations thereof.

According to one aspect of the disclosure, a water-heating system includes a water reservoir, an AC-powered heating element, a DC-powered heating element, and an energy-source selector. The water reservoir includes a storage tank adapted to hold water to be heated. The AC-powered heating element is arranged to heat water in the storage tank when coupled electrically to an alternating current and the DC-powered heating element is arranged to heat water in the storage tank when coupled electrically to a direct current. The energy-source selector is configured to control the AC-powered heating element and DC-powered heating element to selectively heat the water in the storage tank to attain a predetermined temperature, the energy-source selector being used to select from among a plurality of energy-source modes to permit heating of the water in the storage tank using a single selected energy source or a combination of selected energy sources.

In an embodiment, the energy-source selector electrically couples the DC-powered heating element to a renewable-DC energy source in in a first energy-source mode to heat the water in the storage tank. In an embodiment, the energy-source selector electrically couples the AC-powered heating element to an alternating current provided by a utility grid in a second energy-source mode to heat water in the storage tank. In an embodiment, the energy-source selector electrically couples the AC-powered heating element to an alternating current provided by the utility grid and a renewable-AC energy source in a third energy-source mode.

In an embodiment, the energy-source selector electrically couples the AC-powered heating element to an alternating current provided by a utility grid in a first energy-source mode to heat the water in the storage tank. In an embodiment, the energy-source selector electrically couples the AC-powered heating element to alternating current provided by the utility grid and a renewable-AC energy source in a second energy-source mode to heat the water in the storage tank.

In an embodiment, the energy-source selector electrically couples the AC-powered heating element to alternating current provided by a renewable-AC energy source in a third energy-source mode to heat the water in the storage tank. In an embodiment, the energy-source selector electrically couples the DC-powered heating element to direct current provided by a renewable-DC energy source in a fourth plurality of energy-source mode to heat the water in the storage tank.

In an embodiment, the water reservoir further includes a temperature sensor configured to detect a temperature of the water in the storage tank. The energy-source selector is usable to select from three operation modes related to the plurality of energy-source modes. In an embodiment, a first of the three operation modes is configured to heat the water in the storage tank with the AC-powered heating element with alternating current provided by a renewable-AC energy source or the DC-powered heating element with direct current provided by a renewable-DC energy source until a predetermined temperature of the water is met. In an embodiment, a second of the three operation modes is configured to heat the water in the storage tank with the AC-powered heating element with alternating current provided by a utility grid until the predetermined temperature of the water is met. A rate of heating the water in the second operation mode is faster than a rate of heating the water in the first operation mode. In an embodiment, a third of the three operation modes is configured to heat the water in the storage tank with the AC-powered heating element with alternating current provided by the utility grid until a second predetermined temperature of the water is met and then heating the water in the storage tank with the AC-powered heating element with alternating current provided by the renewable-AC energy source or the DC-powered heating element with direct current provided by the renewable-DC energy source until the predetermined temperature of the water is met. The second predetermined temperature of the water is lower than the predetermined temperature of the water.

According to another aspect, a water-heating system includes a water reservoir, a heating unit, an energy-source selector, and a controller. The water reservoir includes a storage tank adapted to hold water to be heated. The heating unit includes an AC-powered heating element arranged to heat water in the storage tank when coupled electrically to an alternating current, a DC-powered heating element arranged to heat water in the storage tank when coupled electrically to a direct current, and a temperature sensor disposed within the storage tank to detect a temperature of the water. The energy-source selector is usable by a user to select an operation mode configured to control the AC-powered heating element and DC-powered heating element to selectively heat the water in the storage tank to attain a predetermined temperature. The controller is coupled to the heating unit and including a processor and a memory device storing instructions that, when executed by the processor, cause at least one of the AC-powered heating element and the DC-powered heating element to heat the water in the storage tank to a predetermined temperature.

In an embodiment, the operation mode is configured to heat the water in the storage tank with the AC-powered heating element with alternating current provided by a renewable-AC energy source until a predetermined temperature of the water is met. In an embodiment, the operation mode is further configured to heat the water with the DC-powered heating element with direct current provided by a renewable-DC energy source until a predetermined temperature of the water is met.

In an embodiment, the operation mode is configured heat the water in the storage tank with the AC-powered heating element with alternating current provided by a utility grid until a predetermined temperature of the water is met.

In an embodiment, the operation mode is configured to heat the water in the storage tank with the AC-powered heating element with alternating current provided by a utility grid until a second predetermined temperature of the water is met and then heating the water in the storage tank with the AC-powered heating element with alternating current provided by a renewable-AC energy source until a predetermined temperature of the water is met, the second predetermined temperature of the water is lower than the predetermined temperature of the water.

In an embodiment, the operation mode is configured to heat the water in the storage tank with the AC-powered heating element with alternating current provided by a utility grid until a second predetermined temperature of the water is met and then heating the water in the storage tank with the DC-powered heating element with direct current provided by a renewable-DC energy source until the predetermined temperature of the water is met. The second predetermined temperature of the water is lower than the predetermined temperature of the water. In an embodiment, the operation mode is further configured to, after the second predetermined temperature of the water is met, heat the water in the storage tank with both the DC-powered heating element with direct current provided by the renewable-direct current energy source and the AC-powered heating element with alternating current provided by a renewable-AC energy source until the predetermined temperature of the water is met. In an embodiment, the renewable-direct current energy source is at least one photovoltaic panel.

According to another aspect, a water-heating system includes a water reservoir, a heating unit, a temperature sensor, a controller, and means for setting a household profile. The water reservoir includes a storage tank adapted to hold water to be heated. The heating unit includes at least one heating element configured to heat water in the storage tank when coupled electrically to at least one of an alternating current, a direct current, or both. The temperature sensor is configured to detect a temperature of the water in the storage tank. The controller is coupled to the heating unit and includes a processor and a memory device storing instructions that, when executed by the processor, causes the at least one heating element to heat the water in the storage tank to at least one predetermined temperature. The means for setting a household profile causes the controller to operate the water-heating system in accordance with a plurality of parameters set by an user which reflect desired operability of the water-heating system by a household. The controller operates the at least one heating element in accordance with the set household profile.

In an embodiment, the plurality of parameters includes a first pair of predetermined temperatures which has a first upper limit temperature and a first lower limit temperature. The controller is configured to deactivate the at least one heating element when the temperature sensor detects the temperature of the water to at or above the first upper limit temperature and to activate the at least one heating element when the temperature sensor detects the temperature of the water to be at or below the first lower limit temperature. In an embodiment, the at least one heating element is communicable with a renewable-AC energy source, and the plurality of parameters includes a time window having a start time and an end time between which the controller is configured to activate and deactivate the at least one heating element using energy from the renewable-AC energy source in accordance with the first pair of predetermined temperatures. In an embodiment, the at least one heating element is communicable with a utility grid, and the plurality of parameters includes a second pair of predetermined temperatures which has a second upper limit temperature and a second lower limit temperature. The controller, outside the time window, is configured to activate and deactivate the at least one heating element using energy from the utility grid in accordance with the second pair of predetermined temperatures. In an embodiment, the first upper limit temperature is greater than the second upper limit temperature and the first lower limit temperature is greater than the second lower limit temperature. In an embodiment, the first pair of predetermined temperatures is greater than the second pair of predetermined temperatures.

In an embodiment, the at least one heating element is communicable with a renewable-DC energy source. In an embodiment, the at least one heating element includes a first heating element that is communicable with the renewable-DC energy source and a second heating element that is communicable with a renewable-AC energy source or a utility grid. In an embodiment, the plurality of parameters includes a second pair of predetermined temperatures which has a second upper limit temperature and a second lower limit temperature. The controller is configured to, when the temperature sensor detects the temperature of the water in the storage tank to be at or below the second lower limit temperature, activate both the first heating element and the second heating element, and when the temperature sensor detects the temperature of the water to be at or above the second upper limit temperature, deactivate the second heating element and allow for the first heating element to remain activated until the water is at or above the first upper limit temperature.

In an embodiment, the means for establishing a household profile includes a plurality of data outputs that are determined based on the household's use of the water-heating system to determine the efficiency of the water-heating system. In an embodiment, the user adjusts one or more of the plurality of parameters based on the plurality of data outputs.

In an embodiment, the means for establishing the household profile is a user interface.

These and other features of the present disclosure will become more apparent from the following description of the illustrative embodiments.

### BRIEF DESCRIPTION OF THE DRAWINGS

FIG. 1 is a perspective view of a water-heating system illustrating a water reservoir, a heating unit, and an energy-source selector associated with the water reservoir, the water reservoir including a storage tank for storing water to be heated and the heating unit used to heat the water in the storage tank, the heating unit including an alternating current (AC)-powered heating element and a direct current (DC)-powered heating element;

FIG. 2 is a schematic view of the water-heating system of FIG. 1 showing that the energy-source selector is communicable between a renewable-DC energy source, a utility grid, and a renewable-AC energy source so that direct current can be provided to the DC-powered heating element by the renewable-DC energy source and alternating current can be provided to the AC-powered heating element by the utility grid and/or the renewable-AC energy source, and further showing that the energy-source selector may be used by a user to select from among seven energy-source modes so that water in the storage tank can be heated using a selected energy source or a combination of selected energy sources at the option of the user;

FIG. 3A is a front elevational view of the water-heating system of FIG. 1 showing the energy-source selector used to control the water-heating system, and showing that the water-heating system further includes a display to provide the user with information about the water-heating system;

FIG. 3B is a rear elevational view of the water-heating system of FIG. 1 showing that the water reservoir includes a water inlet, a water outlet, and that the water-heating system further includes a control unit having a power switch, a DC-input communicable to the renewable-DC energy source and an AC-input communicable to the utility grid and/or the renewable-AC energy source;

FIG. 4 is an exploded view of the water-heating system of FIG. 1 showing that the control unit includes a controller communicatively coupled to the energy-source selector and the heating unit, and further showing that the heating unit includes a temperature sensor communicatively coupled to the controller and adapted to detect and communicate to the controller the temperature of the water in the storage tank;

FIG. 5 is a schematic view of the water-heating system showing that the controller is communicatively coupled to the energy-source selector, the heating unit, and other components of the control unit;

FIG. 6 is a sectional view of the water-heating system taken along line 6-6 of FIG. 3A showing that the storage tank further includes a dip tube coupled to the water inlet and insulation;

FIG. 7A is a schematic view of the water-heating system of FIG. 1 showing the water-heating system connected to the utility grid in a first energy-source mode;

FIG. 7B is a schematic view of the water-heating system of FIG. 1 showing the water-heating system connected to the utility grid and the renewable-AC energy source in a second energy-source mode;

FIG. 7C is a schematic view of the water-heating system of FIG. 1 showing the water-heating system connected to the renewable-DC energy source and the utility grid in a third energy-source mode;

FIG. 7D is a schematic view of the water-heating system of FIG. 1 showing the water-heating system connected to the renewable-DC energy source and also to the utility grid and the renewable-AC energy source in a fourth energy-source mode;

FIG. 7E is a schematic view of the water-heating system of FIG. 1 showing the water-heating system connected to the renewable-DC energy source and to the renewable-AC energy source in a fifth energy-source mode;

FIG. 7F is a schematic view of the water-heating system of FIG. 1 showing the water-heating system connected to the renewable-AC energy source in a sixth energy-source mode;

FIG. 7G is a schematic view of the water-heating system of FIG. 1 showing the water-heating system connected to the renewable-DC energy source in a seventh energy-source mode;

FIG. 8 is a detailed front view of the energy-source selector and the display of the water-heating system of FIG. 1;

FIG. 9 is a detailed rear view of the water-heating system of FIG. 1 showing the water inlet, the water outlet, the DC-input, the AC-input, and the power switch;

FIG. 10 is a schematic of a user interface to be used with the water-heating system of FIGS. 1-9;

FIG. 11A is a detailed view of the user interface of FIG. 10 showing a plurality of temperature inputs configurable by the user;

FIG. 11B is a detailed view of the user interface of FIG. 10 showing a renewable energy source time window input configurable by the user; and

FIGS. 11C-11I are detailed views of the user interface of FIG. 10 showing a plurality of indicators displaying various statuses of the water-heating system.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

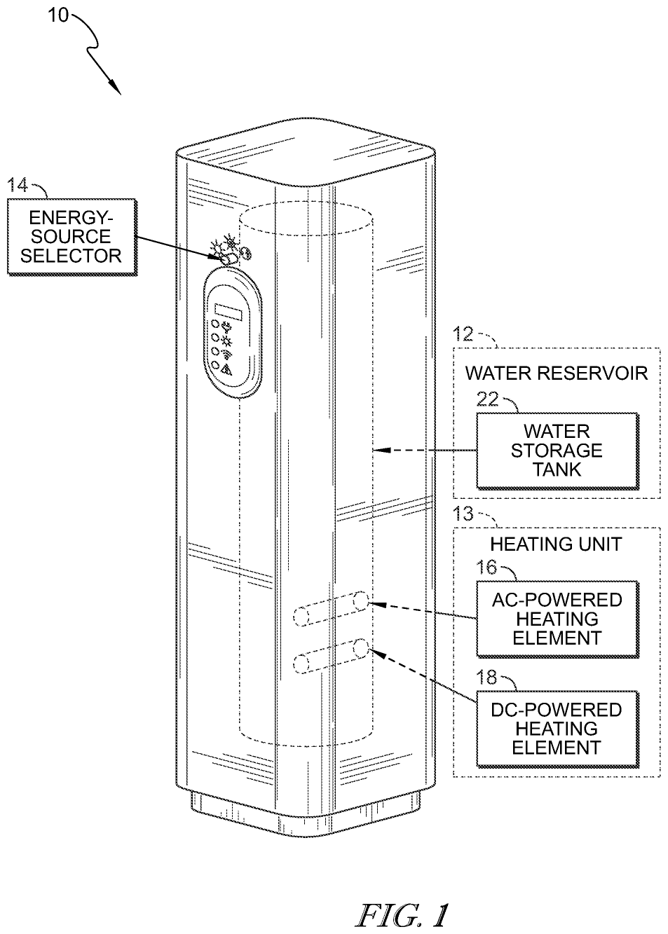

A water-heating system 10 is shown in FIG. 1. The water water-heating system 10 includes a water reservoir 12 adapted to store water to be heated, a heating unit 13 arranged to heat the water stored in the water reservoir, and an energy-source selector 14 configured to control the heating unit 13 to selectively heat the water in the water reservoir 12 to attain a predetermined temperature. The energy-source selector 14 is used to select from among a plurality of energy-source modes to permit heating of the water in the water reservoir 12 using a single selected energy source or a combination of selected energy sources. The energy sources include a renewable-direct current (DC) energy source 48, a renewable-alternating current (AC) energy source 52, and a utility grid 50. The renewable-DC energy source 48 and the renewable-AC energy source 52 may be one or more photovoltaic panels, for example.

As described above, the water-heating system 10 is shown in FIG. 1. The water-heating system 10 includes the water reservoir 12, the heating unit 13, the energy-source selector 14, and a control unit 15. The water reservoir 12 is adapted to store water to be heated. The heating unit 13 includes an AC-powered heating element 16 and a DC-powered heating element 18. The AC-powered heating element 16 and the DC-powered heating element 18 are arranged to heat the water stored in the water reservoir 12. The energy-source selector 14 is configured to control the AC-powered heating element 16 and the DC-powered heating element 18 to selectively heat the water in the water reservoir 12 to attain a predetermined temperature. Accordingly, via the control unit 15 upon input from the energy-source selector 14, the AC-powered heating element 16 is communicable to the renewable-AC energy source 52 and the utility grid 50, while the DC-powered heating element 18 is communicable to the renewable-DC energy source 48.

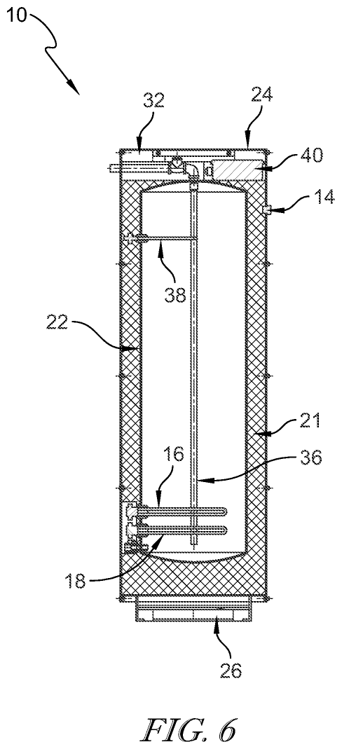

The water reservoir 12 includes housing 20, insulation 21, and a storage tank 22. The housing 20 is configured to enclose the storage tank 22 and the heating unit 13. Insulation 21 is located between the housing 20 and the storage tank 22 as shown in FIG. 6, and may be any insulation 21 suitable for a water-heating system 10. For example, the insulation 21 may be thermal insulation, or thermal insulation free of hydrofluorocarbon. The storage tank 22 is configured to store water to be heated.

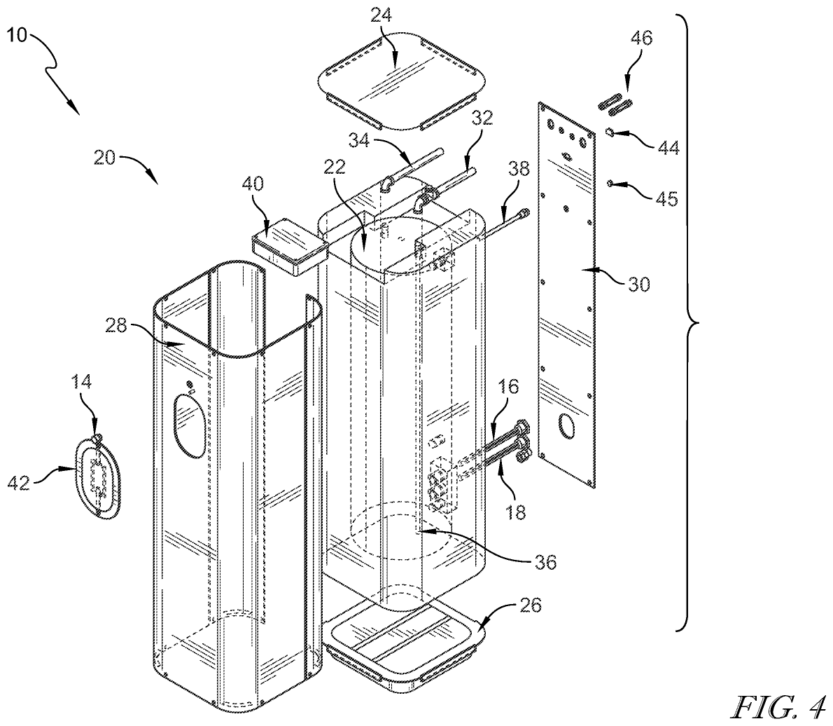

The housing 20 includes a top cover 24, a bottom cover 26, a front casing 28, and a back cover 30 as shown in FIG. 4. The top cover 24, the bottom cover 26, the front casing 28, and/or the back cover 30 may be fabricated from an appropriate material that may be molded in the shape shown in FIG. 1 and capable of withstanding exposure to outdoor weather conditions. The top cover 24, the bottom cover 26, the front casing 28, and/or the back cover 30 may be any sort of polymer, such as an injection molded plastic. In other embodiments, the top cover 24, the bottom cover 26, the front casing 28, and/or the back cover 30 may be a metal such as stainless steel. The top cover 24, the bottom cover 26, the front casing 28, and/or the back cover 30 cooperate, when assembled, to provide a substantially vertical, rectangular shape according to the illustrated embodiment shown in FIG. 1. However, in other embodiments, other shapes may be contemplated, such as cylindrical. The housing 20 may be assembled using fasteners (not shown) such as Allen screws, locknuts, bolts, or any other suitable fastener.

The storage tank 22 may be situated anywhere within the housing 20. The storage tank 22 includes a water inlet 32, a water outlet 34, and a dip tube 36 as shown in FIGS. 4 and 6. The water inlet 32 is communicable to a water source to provide cold water to the water-heating system 10. The water outlet 34 is adapted to output heated water from the water-heating system 10. The dip tube 36 is coupled to the water inlet 32 to supply cold water to the bottom of the storage tank 22. The storage tank 22 may be fabricated from a plastic, glass, or metal material that is capable of holding water at various temperature. In some embodiments, the storage tank 22 may be fabricated from stainless steel.

The storage tank 22 may vary in size depending on the needs of the water-heating system 10. According to a particular embodiment, the storage tank 22 includes a capacity of at least about 1 gallon, 3 gallons, 5 gallons, 10 gallons, 15 gallons, 20 gallons, 25 gallons, 30 gallons, 35 gallons, 40 gallons, 45 gallons, 50 gallons, 55 gallons, 60 gallons, 65 gallons, 70 gallons or 75 gallons, or any specific capacity or range of capacities between about 1 gallon and about 75 gallons.

The water inlet 32 may be in communication with and connected to a water source such as a municipal water source, well water source or a temporary water source such as found at campsite or on a recreational vehicle. The water outlet 34 may be in communication with and connected to water lines that are connected to fixtures in a residential dwelling, commercial building, recreational vehicle, or any structure or vehicle that requires hot water for the various uses provided herein.

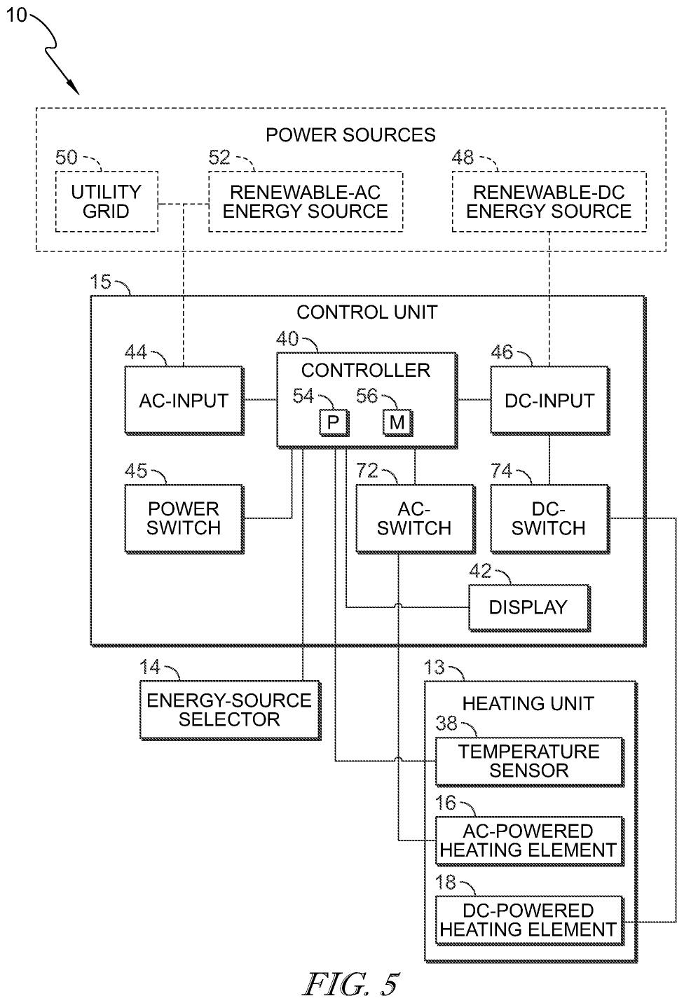

The heating unit 13 includes the AC-powered heating element 16, the DC-powered heating element 18, and a temperature sensor 38 as shown in FIGS. 4 and 5. The AC-powered heating element 16 and the DC-powered heating element 18 are inserted inside the storage tank 22 and are communicatively coupled to the energy-source selector 14 and the control unit 15 to selectively heat the water in the storage tank 22.

The heating elements 16, 18 may be fabricated from an acceptable metal material capable of conducting heat from electric resistance while not being easily subject to rust or scale. According to a particular embodiment, the heating elements 16, 18 may be fabricated from stainless steel or copper. According to another embodiment, the heating elements 16, 18 may be suited to heat water to a safe temperature for a particular end use. That temperature may be at least about 70° F., 80° F., 90° F., 100° F., 110° F., 120° F., or 130° F., 140° F., 150° F., 160° F., 170° F., 180° F., 190° F., 195° F. or 200° F., or any specific temperature or range of temperatures between about 70° F. and about 200° F. In some embodiments, the water may be heated to 120° F.

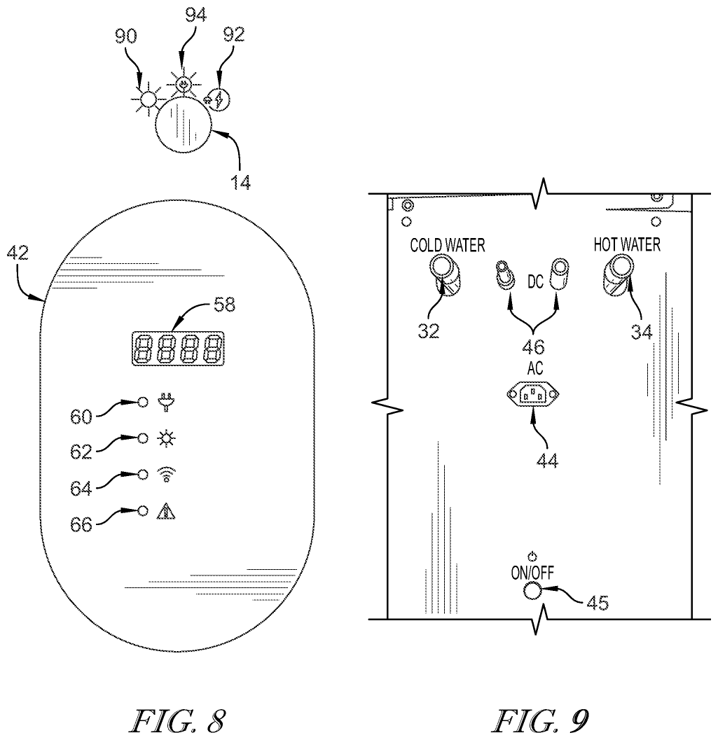

The temperature sensor 38 may be inserted or otherwise mounted inside the storage tank 22 as shown in FIGS. 4 and 6. In the illustrative embodiment, the temperature sensor 38 is connected to or otherwise in electrical communication with a controller 40 of the control unit 15 located outside the storage tank 22 but within the housing 20. In other embodiments, the controller 40 may be located outside the housing 20. The temperature sensor 38 may detect temperature and signal temperature readings to the controller 40 in real-time or substantially real-time. Such temperature readings may be displayed on a display 42 of the control unit 15, as shown in FIGS. 1 and 8, for a user to observe or to be transmitted to a user interface 98 via a WiFi or cellular signal. Such a user interface 98 may include a smart phone application or dedicated electronic keypad.

In the present embodiment, the energy-source selector 14 is a knob 14 that is rotatable as shown in FIGS. 1 and 8. The energy-source selector 14 is rotatable between three positions associated with three operation modes 90, 92, 94 of the water-heating system 10 as described in further detail below, and is communicable with the controller 40 so that upon rotation by a user, the user selectively operates the water-heating system 10 to heat the water in the storage tank 22. Additionally or alternatively, the energy-source selector 14 may be fabricated from a plastic or metal. In the illustrative embodiment, the energy-source selector 14 is located on a front face 70 of the front casing 28. In other embodiments, the energy-source selector 14 may be located anywhere on the housing 20 and/or accessible via an external device such as a mobile phone, computer, or remote. In some embodiments, the energy-source selector 14 may be one or more knobs, one or more switches, and/or one or more push buttons. In some embodiments, the energy-source selector 14 may also be referred to as an operation-mode selector 14.

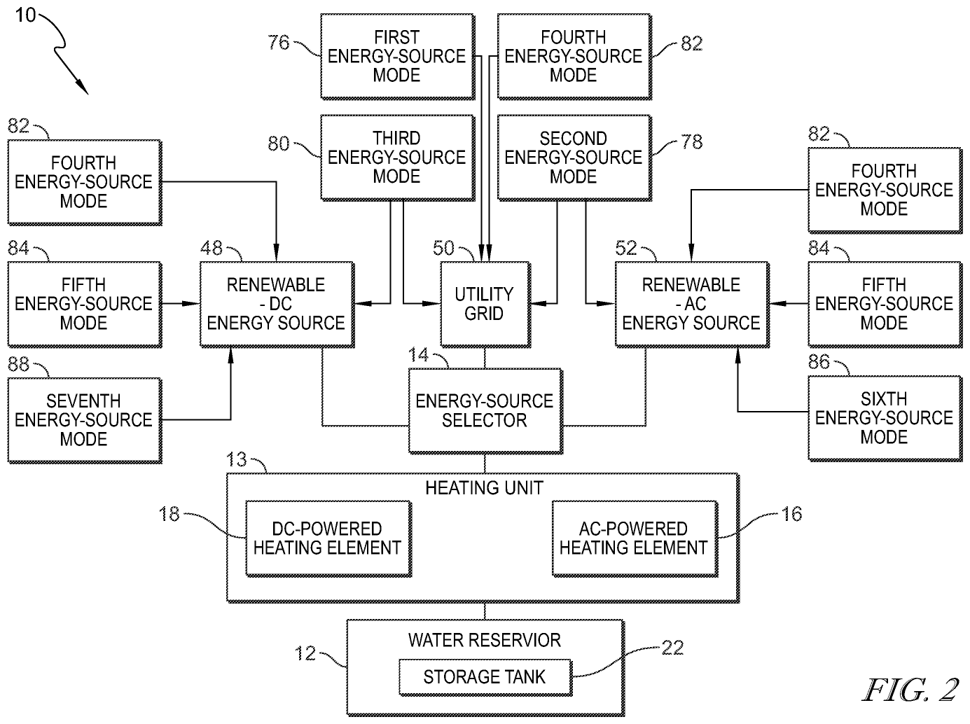

The energy-source selector 14, via the control unit 15, is communicable between a renewable-DC energy source 48, a utility grid 50, and a renewable-AC energy source 52 as shown schematically in FIG. 2 so that direct current can be provided to the DC-powered heating element 18 by the renewable-DC energy source 48 and alternating current can be provided to the AC-powered heating element 16 by the utility grid 50 and/or the renewable-AC energy source 52.

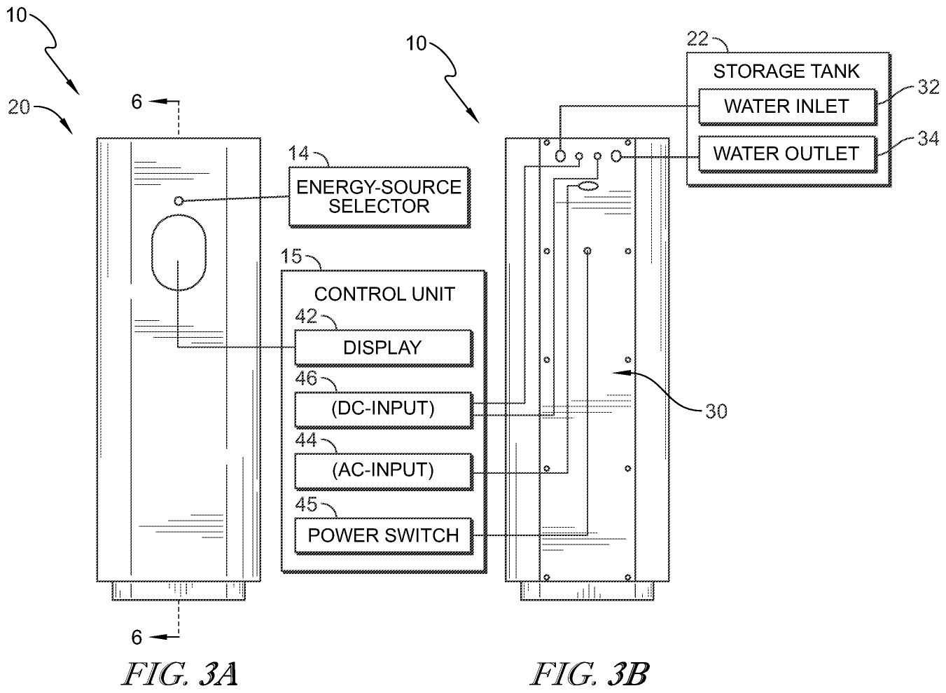

The control unit 15 includes an AC-input 44, a DC-input 46, the controller 40, the display 42, and a power switch 45 as shown in FIGS. 3A-3B and 5. The DC-input 46 is communicable to the renewable-DC energy source 48. The AC-input 44 is communicable to the utility grid 50 and the renewable-AC energy source 52 either individually or collectively. For example, both the energy from the utility grid 50 and the energy from the renewable-AC power source 52 may be available together to connect from a residential or commercial unit's electrical circuit to the AC-input 44. The power switch 52 is adapted to turn the water-heating system 10 on and off.

The controller 40 is communicatively coupled to other components of the control unit 15, the energy-source selector 14 and the heating unit 13. The controller 40 includes a processor 54 and a memory device 56 storing instructions that, when executed by the processor 54, cause at least one of the AC-powered heating element 16 and the DC-powered heating element 18 to heat the water in the storage tank 22 to a predetermined temperature.

The display 42 provides information about the water-heating system 10 to a user as shown in FIG. 8. The display includes a temperature indicator 58 to display the temperature of the water inside the storage tank 22. The temperature indicator 58 is a digital LED screen in the illustrative embodiment, however any type of screen or indicator may be used for the temperature indicator 58 to display the temperature of the water inside the storage tank 22.

The display 42 also includes, as shown in FIG. 8, a first indicator 60 to indicate whether the water-heating system 10 has power, a second indicator 62 to indicate whether the water-heating system 10 is connected to at least one of the renewable-DC energy source 48 and the renewable-AC energy source 52, a third indicator 64 to indicate whether the water-heating system 10 is connected to WiFi or another network, and a fourth indicator 66 to indicate whether the water-heating system 10 is experiencing any errors. In the illustrative embodiment, the indicators 60, 62, 64, and 66 are LED indicators associated with symbols, however any indicator and/or symbol may be used for the indicators 60, 62, 64, and 66 to display the information associated with indicators 60, 62, 64, and 66.

As shown schematically in FIG. 5, the controller 40 may be configured to, among other things, receive a signal from the temperature sensor 38, electrically connect to the renewable-DC energy source 48 via the DC-input 46, electrically connect to the renewable-AC energy source 52 and/or the utility grid 50 via the AC-input 44, receive a signal from the knob 68 indicating the active operation mode that is selectable by the user via the knob 68, receive data through WiFi to remotely modify parameters of the water-heating system 10, and/or receive signals from power meters indicating the amount of AC and/or DC power used. The parameters of the water-heating system 10 may include, among other things, initial setup details, temperature set-points, operation mode, etc.

The controller 40 may also be configured to, among other things, electrically connect to the AC-powered heating element 16, electrically connect to the DC-powered heating element 18, electrically connect to the display 42 to display water temperature and additional information, and send data through WiFi, such data including but not limited to, temperature values, power consumption by energy source 48, 50, 52, operation mode, and any other relevant information. In the illustrative embodiment, the electrical connection between the controller 40 and the AC-powered heating element 16 includes a first switch 72 of the controller 40 to selectively control the AC-powered heating element 16 and the electrical connection between the controller 40 and the DC-powered heating element 18 includes a second switch 74 of the controller 40 to selectively control the DC-powered heating element 18. In other embodiments, the first switch 72 and/or the second switch 74 may each be a relay.

The energy-source selector 14 is configured to control the AC-powered heating element 16 and the DC-powered heating element 18 via the control unit 15 to selectively heat the water in the storage tank 22 to attain a predetermined temperature. The energy-source selector 14 is used to select from three operation modes which are in turn related to a plurality of energy-source modes to permit heating of the water in the storage tank 22 using a single selected energy source or a combination of selected energy sources.

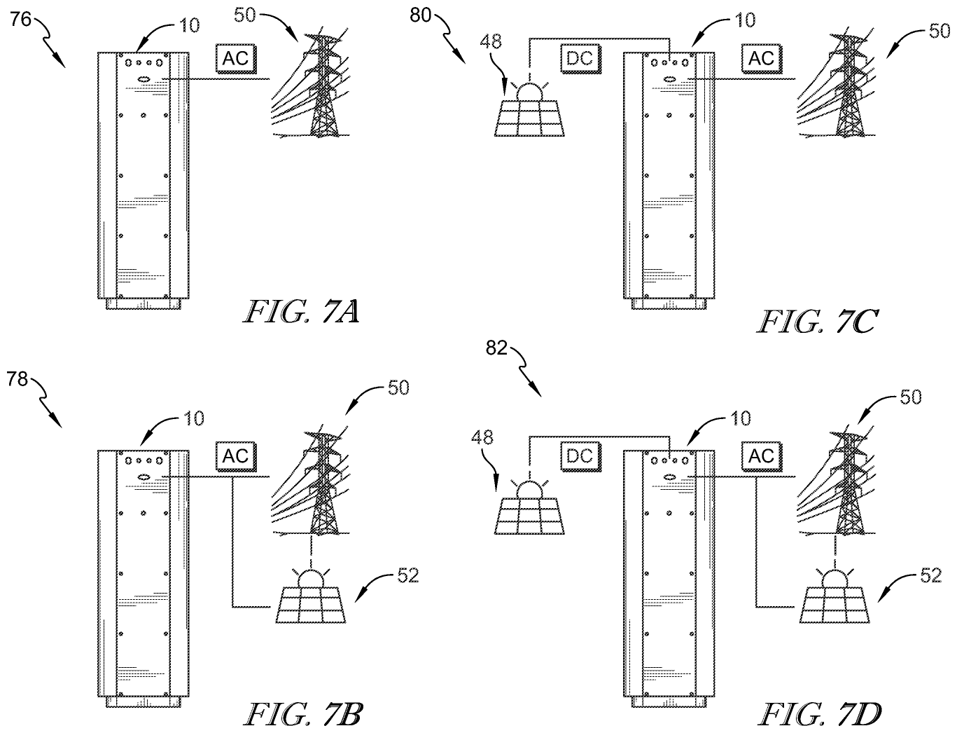

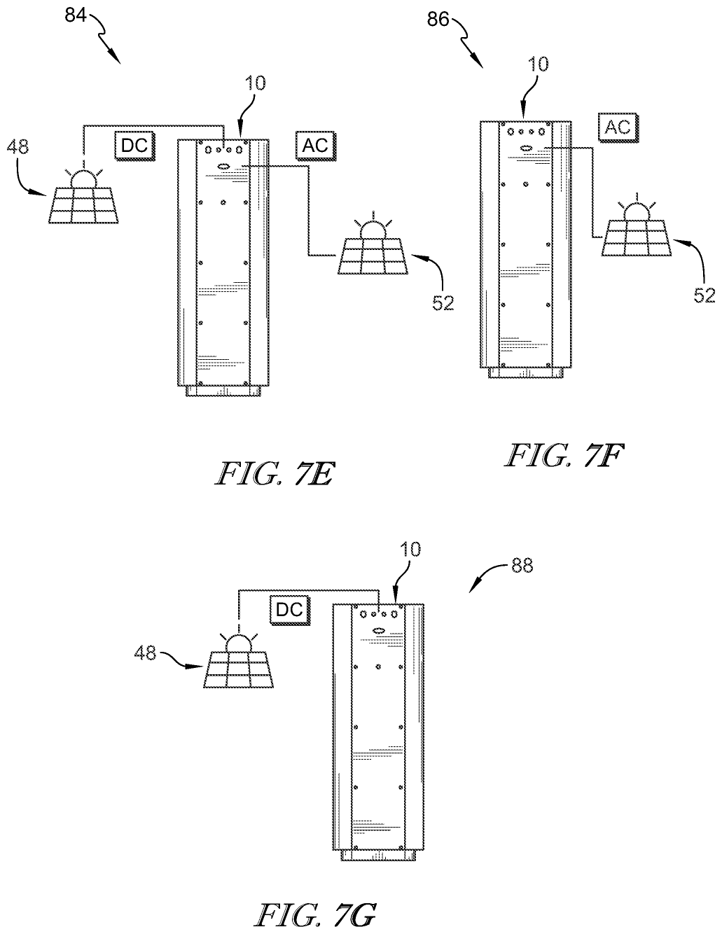

In a first energy-source mode 76 shown in FIG. 7A, the energy-source selector 14 causes the first switch 72 to electrically couple the AC-powered heating element 16 to the utility grid 50 to heat the water in the storage tank 22. In the first energy-source mode 76, the water-heating system 10 operates as a conventional electrical water heater.

In a second energy-source mode 78 shown in FIG. 7B, the energy-source selector 14 causes the first switch 72 to electrically couple the AC-powered heating element 16 to both the utility grid 50 and the renewable-AC energy source 52. In the second energy-source mode 78, the energy from the renewable-AC energy source 52 and the utility grid 50 are combined at the AC-input 44 or earlier such that the AC current delivered to the water-heating system 10 is a combination of the renewable-AC energy source 52 and the utility grid 50.

In a third energy-source mode 80 shown in FIG. 7C, the energy-source selector 14 causes the first switch 72 to electrically couple the AC-powered heating element 16 to the utility grid 50 and the second switch 74 to electrically couple the DC-powered heating element 18 to the renewable-DC energy source 48 to heat the water in the storage tank 22.

In a fourth energy-source mode 82 shown in FIG. 7D, the energy-source selector 14 causes the first switch 72 to electrically couple the AC-powered heating element 16 to both the utility grid 50 and the renewable-AC energy source 52 and the second switch 74 to electrically couple the DC-powered heating element 18 to the renewable-DC energy source 48 to heat the water in the storage tank 22. In the fourth energy-source mode 82, the AC current delivered to the water-heating system 10 is in the same manner as in the second energy-source mode 78. Accordingly, in the fourth energy-source mode, all three power sources are available and connected to the water-heating system 10 as shown in FIG. 7D.

In a fifth energy-source mode 84 shown in FIG. 7E, the energy-source selector 14 causes the first switch 72 to electrically couple the AC-powered heating 16 to the renewable-AC energy source 52 and the second switch 74 to electrically couple the DC-powered heating element 18 to the renewable-DC energy source 54 to heat the water in the storage tank 22.

In a sixth energy-source mode 86 shown in FIG. 7F, the energy-source selector 14 causes the first switch 72 to electrically couple the AC-powered heating element 16 to the renewable-AC energy source 52 to heat the water in the storage tank 2.

In a seventh energy-source mode 88 shown in FIG. 7G, the energy-source selector 14 causes the second switch 74 to electrically couple the DC-powered heating element 18 to the renewable-DC energy source 48 to heat the water in the storage tank 22.

The three operation modes 90, 92, 94 are selectable by a user via the energy-source selector 14 to heat the water with one of the plurality of energy-source modes. Alternatively or additionally, the three operation modes 90, 92, 94 may be selectable by a user via an application or other suitable user interface 98 via a WiFi or cellular signal as provided herein, which is described in further detail below. Accordingly, in some embodiments, the water-heating system 10 may be integrated with different appliances or automated or remotely controlled items as part of an IoT network.

A first operation mode 90 shown schematically in FIG. 8, also referred to as a renewable only mode 90 or solar mode 90, is configured to heat the water in the storage tank 22 using energy from one or both of the renewable energy sources 48, 52. As such, the first operation mode 90 may use one of the second energy-source mode 78, the third energy-source mode 80, the fourth energy-source mode 82, the fifth energy-source mode 84, the sixth energy-source mode 86, and the seventh energy-source mode 88. The water-heating system 10 may include or otherwise store heated water until a first predetermined threshold temperature (T₁) is met. If the water-heating system 10 is only working with renewable energy, daylight hours may be used to reach a desired water temperature in this first operation mode 90. The first operation mode 90 may be used to save costs of operating the water-heating system 10 and reduce CO₂ emissions caused by the water-heating system 10. In the first operation mode 90, the water-heating system 10 uses exclusively renewable energy, such as solar energy, when available.

A second operation mode 92 shown schematically in FIG. 8, also referred to as a booster mode 92, is configured give priority to hot water demand rather than renewable energy usage so that the water in the storage tank 22 is heated faster with energy from the utility grid 50 and/or an AC power source including the utility grid 50 and the renewable-AC power source 52. As such, the second operation mode 92 may use one of first energy-source mode 76, the second energy-source mode 78, the third energy-source mode 80, the fourth energy-source mode 82, the fifth energy-source mode 84, and the sixth energy-source mode 86. The water-heating system 10 may also function as a conventional electric water heater in the second operation mode 92 when no renewable energy is available from either or both the renewable-DC power source 48 and the renewable-AC power source 52. The water-heating system 10 may include or otherwise heat the water until a second predetermined threshold temperature (T₂) is met. For example, in the second operation mode 92, the DC-powered heating element 18 may be activated if renewable energy, such as solar energy, is available and simultaneously the AC-powered heating element 16 may be activated to increase the speed of water heating until T₂ is met or a user disables the second operation mode 92, whichever comes first.

A third operation mode 94 shown schematically in FIG. 8, also referred to as a hybrid mode 94, is configured to give priority to the usage of renewable energy, but the utility grid 50 is used to complement the water heating when there are fluctuations in the supply of renewable energy. As such, the second operation mode 92 may use one of first energy-source mode 76, the second energy-source mode 78, the third energy-source mode 80, the fourth energy-source mode 82, the fifth energy-source mode 84, and the sixth energy-source mode 86. In the third operation mode 94, water may be heated with one or both of the renewable-AC energy source 52 and the renewable-DC energy source 48 until the first predetermined threshold temperature (Ti) is met. In the event where there isn't enough power available from one or both of the renewable-AC energy source 52 and the renewable-DC energy source 48 and the temperature of the water is below a third predetermined threshold temperature (T₃), with T₃ being less than Ti, then energy from the utility grid 50 and or the renewable-AC energy source 52 will be used until the third predetermined threshold temperature (T₃) is met.

The water-heating system 10 may also provide capabilities of a thermal battery by transforming renewable energy, such as solar energy, into thermal energy (i.e., hot water). Thus, the water-heating system 10 is able to maintain the temperature of the water in the storage tank 22 for a longer time than a conventional water heater. Additionally, the water-heating system 10 may be able to be used a substitute for an electric battery by storing extra energy as hot water. Finally, the water-heating system 10 may be connectable to a battery system at the DC-input 46 to heat the water in the storage tank 22 when renewable energy, such as solar energy, is not available.

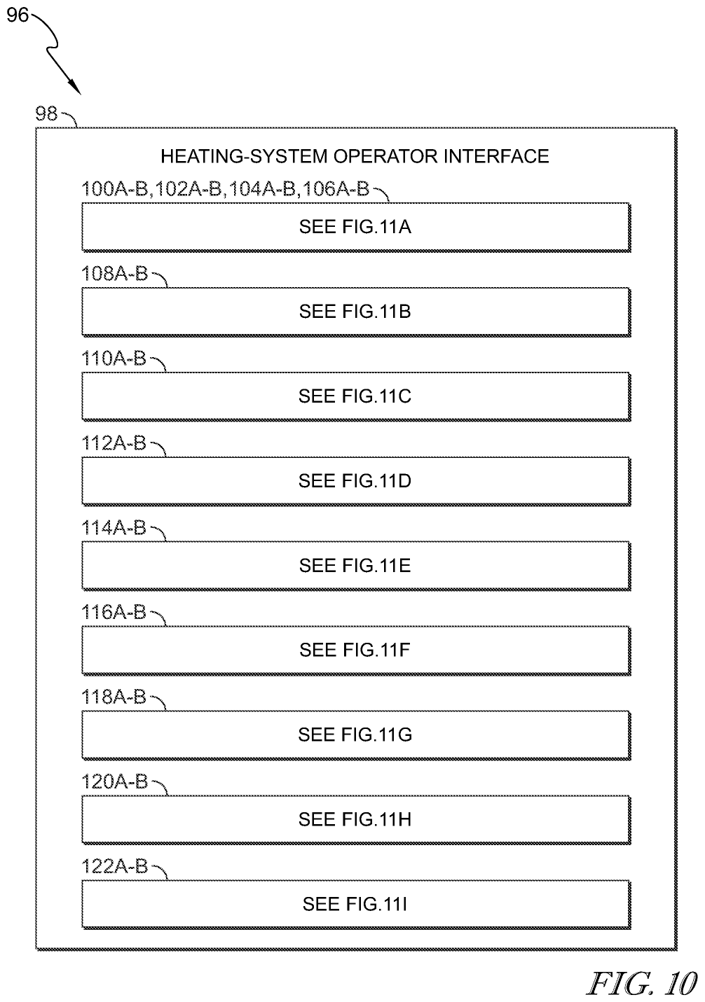

The water-heating system 10 of the present disclosure may further comprise means for establishing a household profile 96 to operate the water-heating system 10 in accordance with the needs of a household while maximizing efficiency of the water-heating system 10. The means for establishing the household profile 96 includes a plurality of parameters determined and set by an installer of water-heating system 10 and/or a user in order to accommodate the needs of a household in which the water-heating system 10 is installed. Additionally, the means for establishing the household profile 96 includes a plurality of data outputs determined based on the household's use of the water-heating system 10 to determine the efficiency of the water-heating system 10 and adjust the plurality of parameters accordingly. The means for establishing the household profile 96 in the present embodiment is shown as the user interface 98 in FIG. 10. In other embodiments, the means for establishing the household profile 96 may be a webpage, a spreadsheet, or any other program or software configured to receive operator inputs and generate data outputs.

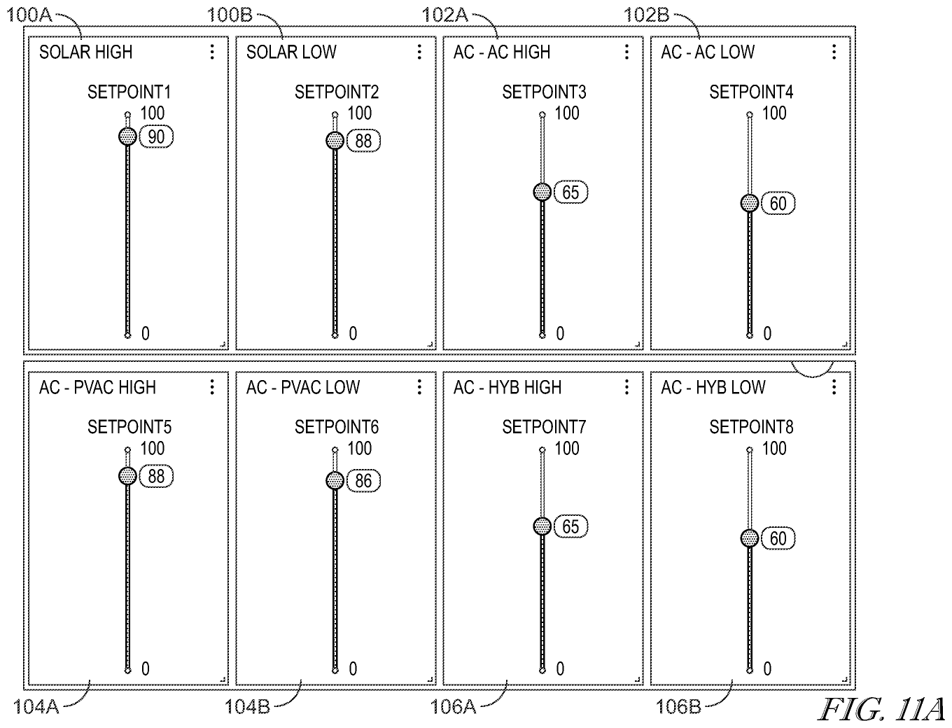

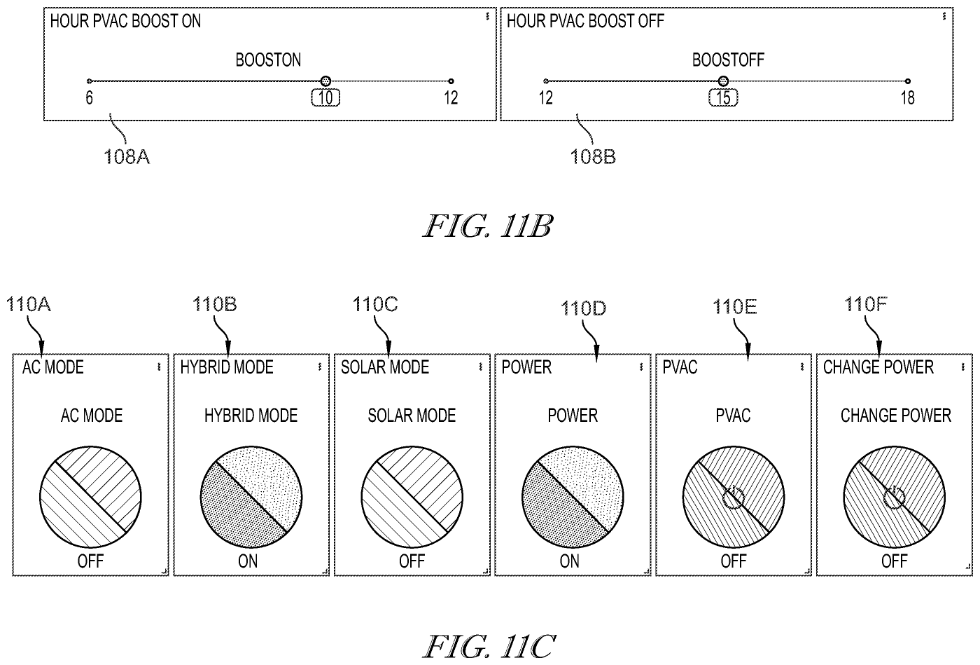

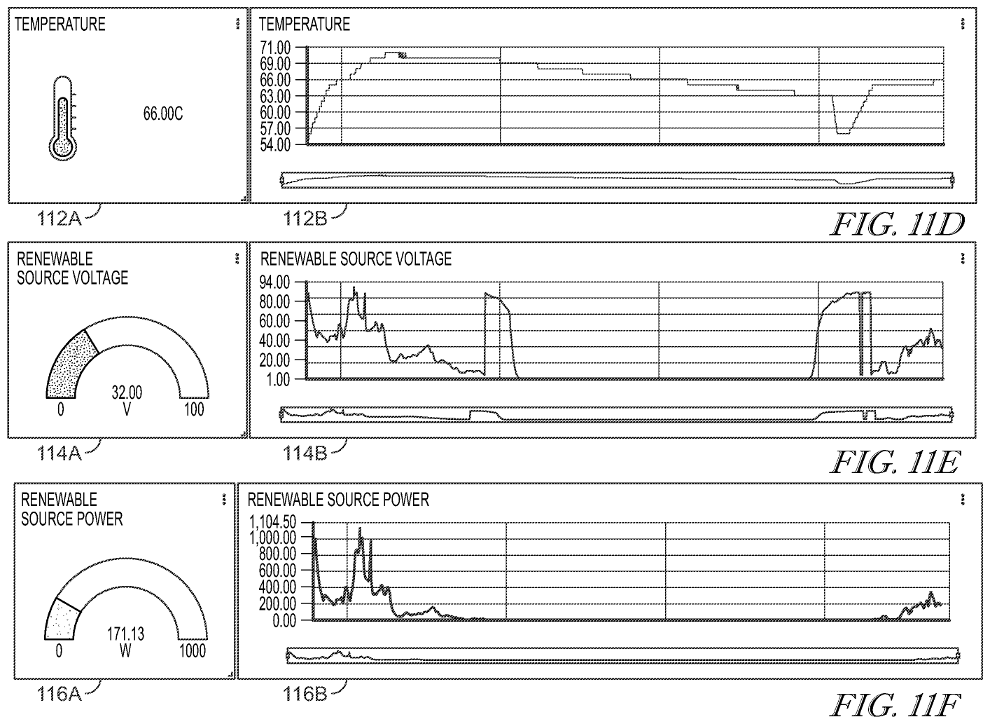

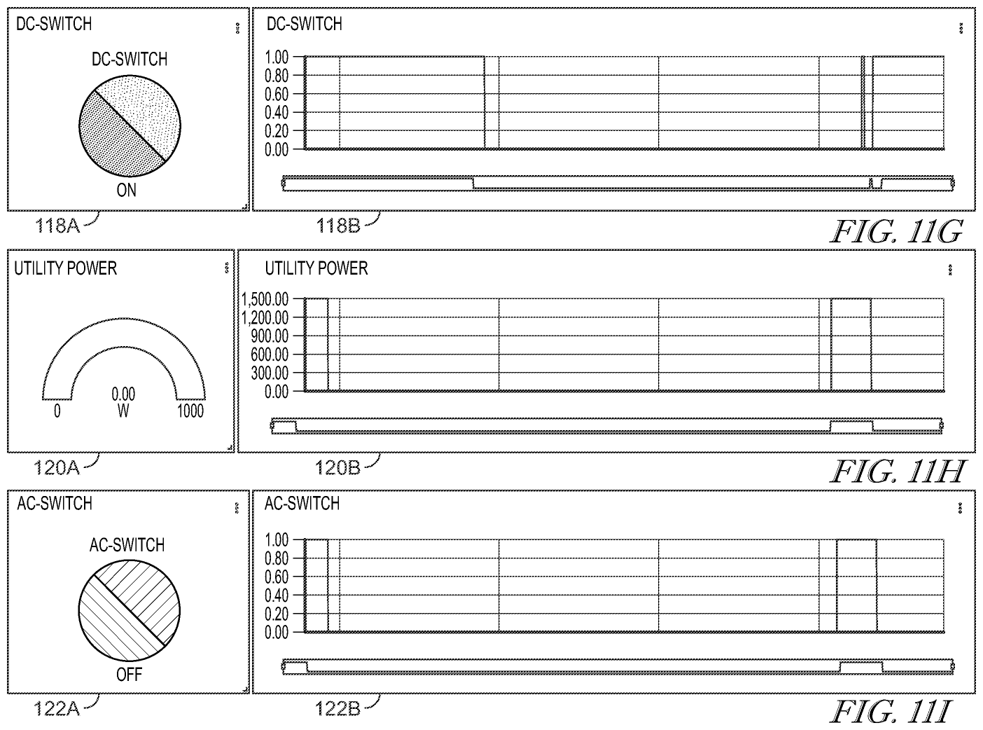

The user interface 98 shown in FIGS. 10 and 11A-11B has a plurality of system inputs or parameters which includes a first pair of predetermined temperatures 100A, 100B, a second pair of predetermined temperatures 102A, 102B, a third pair of predetermined temperatures 104A, 104B, a fourth pair of predetermined temperatures 106A, 106B, and a renewable energy source time window 108A, 108B. This plurality of inputs is utilized to establish the household profile 96 and are adjusted according to the needs of the household upon installation of the water-heating system 10 or a desire to improve the efficiency of a currently operating water-heating system 10. The plurality of inputs may include less than or more than four pairs of predetermined temperatures, more than one renewable energy source time window, and/or additional inputs related to predetermined temperatures or time windows for the operation of the water-heating system 10.

The pairs of predetermined temperatures 100A-108B shown in FIG. 11A determine an upper limit temperature (100A, 102A, 104A, 106A) at which the controller 40 deactivates one or more heating elements 16, 18 and a lower limit temperature (100B, 102B, 104B, 106B) at which the controller 40 activates one or more heating elements 16, 18. The upper limit temperature (100A, 102A, 104A, 106A) may be any temperature described earlier. In some embodiments, the user interface 98 may block the user from setting the upper limit temperature (100A, 102A, 104A, 106A) to be greater than about 194° F. In other embodiments, the upper limit temperature (100A, 102A, 104A, 106A) may be set based on safety, tank steam accumulation prevention, or suitability of the household's plumbing system to accommodate higher water temperatures. Likewise, the user interface 98 may block the user from setting the lower limit temperature (100B, 102B, 104B, 106B) less than about 50° F. and about 60° F. In other embodiments, the lower limit temperature (100B, 102B, 104B, 106B) may be set based on maintaining enough hot water for at least 1 or 2 household members, maintaining power to store solar energy during the day, and/or accommodating a household with a heavy pattern of hot water use.

The difference between the upper limit temperature (100A, 102A, 104A, 106A) and the lower limit temperature (100B, 102B, 104B, 106B) within a specific pair of temperatures may be minimized in order to maximize the use of renewable energy, such as solar energy, while it is available during the daytime. For example, if the household prefers to have hot water at the end of the day, minimizing the difference between the upper limit temperature (100A, 102A, 104A, 106A) and the lower limit temperature (100B, 102B, 104B, 106B) within a specific pair of temperatures may be desired.

The renewable energy source time window 108A, 108B shown in FIG. 11B determines a start time 108A and an end time 108B between which the controller 40 activates one or more heating elements 16, 18 using energy from one or more renewable energy sources 48, 52. Specifically, the renewable source time window 108A, 108B may be used when a smart meter is not available to manage any surplus energy in the water-heating system 10. The renewable energy source time window 108A, 108B may be set to accommodate daylight hours where solar energy is used by the water-heating system, for example.

The user interface 98 may further include a plurality of system indicators 110A-F, 112A-B, 114A-B, 116A-B, 118A-B, 120A-B, 122A-B shown in FIGS. 11C-I which provide the status of various operation modes, switches, and/or other sub-systems or devices of the water-heating system 10. The plurality of system indicators may also provide a plurality of data outputs calculated or measured from the water-heating system 10 and can be used by the user to determine the efficiency of the water-heating system 10 and adjust the plurality of parameters accordingly.

Referring to FIG. 11A, the first pair of predetermined temperatures 100A, 100B are used by the controller 40 to activate or deactivate the DC-powered heating element 18 in both the first operation mode 90 and the third operation mode 94 when using one of the third energy-source mode 80, the fourth energy-source mode 82, the fifth energy-source mode 84, and the seventh energy-source mode 88, or in other words, when the energy-source selector 14 is connected to the renewable-DC energy source 48.

The second pair of predetermined temperatures 102A, 102B are used by the controller 40 to activate or deactivate the AC-powered heating element 16 in in the second operation mode 92 when using one of the first energy-source mode, 76, the second energy-source mode 78, the third energy-source mode 80, the fourth energy-source mode 82, the fifth energy-source mode 84, and the sixth energy-source mode 86, or in other words, when the energy-source selector 14 is connected to one or both the utility grid 50 and the renewable-AC energy source 52. In the present embodiment, the second pair of predetermined temperatures 102A, 102B are both less than the first pair of predetermined temperatures 100A, 100B.

The third pair of predetermined temperatures 104A, 104B are used by the controller 40 to activate or deactivate the AC-powered heating element 16 in both the first operation mode 90 and the third operation mode 94 when using one of the second energy-source mode 78, the fourth energy-source mode 82, the fifth energy-source mode 84, and the sixth energy-source mode 86, or in other words, when the energy-source selector 14 is connected to the renewable-AC energy source 52 and/or prioritized over the utility grid 50. The third pair of predetermined temperatures 104A, 104B may also be utilized by the controller 40 to activate or deactivate the AC-powered heating element 16 during the renewable energy source time window 108A, 108B.

The fourth pair of predetermined temperatures 106A, 106B are used by the controller 40 to activate or deactivate the AC-powered heating element 16 in the third operation mode 94 when using one of the second energy-source mode 78, the fourth energy-source mode 82, the fifth energy-source mode 84, and the sixth energy-source mode 86, or in other words, when the energy-source selector 14 is connected to the renewable-AC energy source 52 and/or prioritized over the utility grid 50. The fourth pair of predetermined temperatures 106A, 106B may also be utilized by the controller 40 to activate or deactivate the AC-powered heating element 16 outside of the renewable energy source time window 108A, 108B. In the present embodiment, the fourth pair of predetermined temperatures 106A, 106B are both less than the third pair of predetermined temperatures 104A, 104B.

By way of example, assume that the DC-powered heating element 18 is connected to the renewable-DC energy source 48 and the AC-powered heating element 16 is connected to one or both of the utility grid 50 and the renewable-AC energy source 52. When the water-heating system 10 is in the first operation mode 90, then the AC-powered heating element 16 may be deactivated and the DC-powered heating element 18 may be activated when the temperature sensor 38 detects the temperature of the water in the storage tank 22 is at or less than the first lower limit temperature 100B and deactivated when the temperature of the water in the storage tank 22 is at or greater than the first upper limit temperature 100A. Additionally or alternatively, the AC-powered heating element 16, if connected to the renewable-AC energy source, may be activated during the renewable energy source time window 108A, 108B when the temperature of the water in the storage tank 22 is at or less than the third lower limit temperature 102B and deactivated when the temperature of the water in the storage tank 22 is at or greater than the third upper temperature limit 102A.

Continuing with the example described above, when the water-heating system 10 is in the second operation mode 92, then both the AC-powered heating element 16 (whether powered by the utility grid 50 or the renewable-AC energy source 52) and the DC-powered heating element 18 are activated when the temperature of the water is at or less than the second lower limit temperature 102B, only the DC-powered heating element 18 is activated when the temperature of the water is at or less than the first lower limit temperature 100B and at or greater than the second upper limit temperature 102A and none of the heating elements 16, 18 are activated when the temperature of the water is at or greater than the first upper limit temperature 100A.

Finally, when the water-heating system 10 is in the third operation mode 94, then the heating elements 16, 18 are activated based on the first pair of predetermined temperatures 100A, 100B and the third pair of predetermined temperatures 104A, 104B, with priority given to either or both the DC-powered heating element 18 and the AC-powered heating element 16 if the AC-powered heating element 16 is connected to the renewable-AC energy source 52 during the renewable energy source time window 108A, 108B. Additionally, if the AC-powered heating element is also connected to the utility grid 50, then outside of the renewable energy source time window 108A, 108B, the AC-powered heating element 16 is activated when the temperature of the water is at or less than the fourth lower limit temperature 106B and the AC-powered heating element 16 is deactivated when the temperature of the water is at or greater than the fourth upper limit temperature 106A.

Referring to FIG. 11C, the user interface 98 may further include a plurality of system indicators including a first operation mode indicator 110C indicating whether the first operation mode 90 is selected, a second operation mode indicator 110A indicating whether the second operation mode 92 is selected, and a third operation mode indicator 110B indicating whether the third operation mode 94 is selected. The plurality of system indicators also includes a power indicator 110D indicating the position of the power switch 45, a renewable-AC energy source indicator 110E indicating whether the renewable-AC energy source 52 is both connected to the water-heating system 10 and being used by the water-heating system 10. The indicators 110A-110E may also be digital or physical switches, buttons, etc. which permit the user to change the status of the indicator. For example, the user may change the operation mode between indicators 110A-110C. The plurality of system indicators also includes a remote power switch 110F which allows the user to remotely power off or on the water-heating system 10. The remote power switch 110F may be a digital or physical switch, button, etc.

Referring to FIG. 11D, the plurality of system indicators also includes a tank temperature status 112A displaying the current temperature of the water detected by the temperature sensor 38 and a tank temperature tracker 112B displaying the temperature of the water detected by the temperature sensor 38 over time.

Referring to FIG. 11E, the plurality of system indicators also includes a renewable source voltage status 114A displaying a current voltage of one or both of the renewable energy sources 48, 52 detected by the controller 40, such as solar panels, and a renewable source voltage tracker 114B displaying the voltage of one or both of the renewable energy sources 48, 52 detected by the controller 40 over time.

Referring to FIG. 11F, the plurality of system indicators also includes a renewable source power status 116A displaying a current power of one or both of the renewable energy sources 48, 52 detected by the controller 40, such as solar panels, and a renewable source power tracker 116B displaying the voltage of one or both of the renewable energy sources 48, 52 detected by the controller 40 over time.

Referring to FIG. 11G, the plurality of system indicators also includes a DC-switch status 118A displaying whether the DC-powered heating element 18 is being used, and a DC-switch tracker 118B displaying use of the DC-powered heating element 18 over time.

Referring to FIG. 11G, the plurality of system indicators also includes a utility grid power status 120A displaying a current power of the utility grid 50 detected by the controller 40, and a utility grid power tracker 120B displaying the power of the utility grid 50 over time.

Referring to FIG. 11H, the plurality of system indicators also includes an AC-switch status 122A displaying whether the AC-powered heating element 16 is being used, and an AC-switch tracker 122B displaying use of the AC-powered heating element 16 over time.

The time span shown in trackers 112B, 114B, 116B, 118B, 120B, 122B may vary from temperature detected during one hour to temperature detected during one year.

According to the present embodiment, the water-heating system 10 may operate consistently across all possible operation modes 90, 92, 94 independent of the number of power sources connected, while being ready to function without any special configuration or installation. The water-heating system 10 allows for the usage of two separated power circuits for AC and DC, the combination of AC renewable and grid power independent from and upstream the system 10, and the ability to infer what type of power (renewable, grid or a combination) is coming through the AC-input 44.

According to the present embodiment, the controller 40 is robust and includes a means for automatically switching between (a) renewable energy in direct current; (b) renewable energy in alternating current; (c) utility power in alternating current; and (d) any combination thereof. Such means include reliable control logic to cover all possible operation scenarios. Such control logic is based on dynamic predetermined temperatures that can change throughout the day, alternatively responding to data signals with the information of the available power per source 48, 50, 52 at a given moment and determining selectively operation of the first and second heating elements 16, 18. Since the energy coming from the renewable-AC power source 52 and the energy from the utility grid 50 are combined before reaching the water-heating system 10, the controller 40 has a mechanism that identifies the type of energy (renewable or grid) that is being fed to the system through the AC-input 44 at any time in order to make decisions based on that information. This mechanism is designed to work in two different ways depending on the information available at the time of operation:
(1) Direct detecting (sensing or obtaining data signals) of any energy surplus available in the renewable-AC energy source 52, which can be done in different ways including the installation of a power meter at the entry of the household's electrical circuit; or
(2) Defining a time window on which energy surplus is produced. This can be done based on historic data for a specific installation (installed capacity of the renewable energy system, energy consumption, geographical location, time of year, etc.) or can be taken directly if the typical energy balance is known for the current water-heating system 10, or also the time window can be dynamically calculated through numerical algorithms.

With such a configuration, if energy surplus is available from the renewable-AC power source 52, such energy would be prioritized and stored in the water-heating system 10 based on the predetermined temperatures. If there is not an energy surplus, the water-heating system 10 will function according to the selected operation mode 90, 92, 94 as described herein.

The present water-heating system 10 provides an easy plug and play solution for overcoming operational restraints while being able to receive and operate with different types of renewable energy sources 48, 52 as well as different current types (AC/DC) simultaneously while also being able to connect to the utility grid 50. The water-heating system 10 allows for the reduction of energy consumption and also allows the replacement of high emissions sources, such as fossil fuels.

According to the present embodiment, the water-heating system 10 can work with three different energy sources 48, 50, 52 with only two power inputs 44, 46. This way, the water-heating system 10 joins all power sources 48, 50, 52 in two different categories: a first power connection coming from the renewable-DC energy source 48, and a second power connection coming from the AC sources (renewable 52 and grid 50). Such a configuration allows the water-heating system 10 to be simpler, which also means that the water-heating system 10 does not require a special electrical connection in cases where the water-heating system 10 is setup to work in AC. According to one embodiment, the water-heating system 10 may be plugged in directly to the residential or commercial electrical circuit.

Methods of Use/End Uses

(1) Residential Use—Increased Energy Storage Capacity

According to one embodiment, the water-heating system 10 could be used as thermal energy storage for residential households where renewable energy storage systems are installed and there is a desire to increase the energy storage capacity and/or increase auto consumption. The water-heating system 10 may also function in addition to preexisting electric batteries or as a single manner to store renewable energy surplus in water held in the storage tank 22. Such a thermal storage energy system can be connected to the household electrical circuit and could use any available energy surplus to heat water in the storage tank 22. According to one embodiment, the thermal storage energy system may be utilized in a residential setting for heating water for various purposes or uses. According to one such embodiment, the heated water may be utilized for human consumption during daily activities such as showering, cooking, washing clothes, or washing dishes.

(2) Water Heating

Domestic hot water uses about 35% of the total energy use of households. If this share of energy could be obtained for virtually no cost, such a lowered cost could have a major impact on the household's energy budget. The water-heating system 10 provided herein may be used as a sustainable water heater for supplying domestic hot water to a residential household. The water-heating system 10 may be connected to the household electrical circuit and water system. The household may optionally have a renewable energy system installed. If there is not a renewable energy system installed, the water-heating system may work as an electric water heater only much more efficient than currently available conventional tank water heaters. When renewable energy is available, the water-heating system would detect such a renewable power source and use this renewable source to heat water. The control logic of the water-heating system 10 may be designed to maximize the utilization of renewable energy such that the use of utility power or fossil fuels for water heating would be reduced to a minimum.

(3) Space Heating

The present water-heating system 10 may also be used as a combination system that provides both residential hot water plus spacing heating to the residence. The water-heating system may be connected to the household electrical circuit, water system, and may be integrated with the space water-heating system as well. This could be done by connecting a heat exchanger to the hot water system that would provide heat to the space water-heating system.

(4) Other Uses

The possible applications of the presented water-heating system 10 are not limited by the examples shown above. Depending on multiple factors and the specific scenario, the water-heating system 10 may also be used for several more applications, one of which is providing space cooling for the household.

All uses and embodiment presented herein can be easily scaled-up to meet applications in the commercial sector, to provide domestic hot water, space heating, space cooling, and other relevant uses for commercial buildings. All uses and embodiment presented herein can be easily scaled-down to meet applications in the recreational sector such as use in recreational vehicles.

Although specific embodiments of the present invention are herein illustrated and described in detail, the invention is not limited thereto. The above detailed descriptions are provided as exemplary of the present invention and should not be construed as constituting any limitation of the invention. Modifications will be obvious to those skilled in the art, and all modifications that do not depart from the spirit of the invention are intended to be included with the scope of the appended claims.

A residential laboratory prototype of a water heater was developed. After this was done satisfactorily, four different water heater prototypes of different water heating capacities were deployed to experimentally test these models under real-life conditions. Experimental data along with user's feedback allowing the fine tuning of set point values and other parameters to improve the system behavior and customer experience.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

### Examples

Illustrative examples of the technologies described herein are provided below. An embodiment of the technologies may include any one or more, and any combination of, the examples described below.

Example 1 includes a water-heating system comprising a water reservoir including a storage tank adapted to hold water to be heated, an AC-powered heating element arranged to heat water in the storage tank when coupled electrically to an alternating current, a DC-powered heating element arranged to heat water in the storage tank when coupled electrically to a direct current, and an energy-source selector configured to control the AC-powered heating element and DC-powered heating element to selectively heat the water in the storage tank to attain a predetermined temperature, the energy-source selector being used to select from among a plurality of energy-source modes to permit heating of the water in the storage tank using a single selected energy source or a combination of selected energy sources.

Example 2 includes the subject matter of Example 1, and wherein the energy-source selector electrically couples the DC-powered heating element to a renewable-DC energy source in in a first energy-source mode to heat the water in the storage tank.

Example 3 includes the subject matter of any of Examples 1 and 2, and wherein the energy-source selector electrically couples the AC-powered heating element to an alternating current provided by a utility grid in a second energy-source mode to heat water in the storage tank.

Example 4 includes the subject matter of any of Examples 1-3, and wherein the energy-source selector electrically couples the AC-powered heating element to an alternating current provided by the utility grid and a renewable-AC energy source in a third energy-source mode.

Example 5 includes the subject matter of any of Examples 1-4, and wherein the energy-source selector electrically couples the AC-powered heating element to an alternating current provided by a utility grid in a first energy-source mode to heat the water in the storage tank.

Example 6 includes the subject matter of any of Examples 1-5, and wherein the energy-source selector electrically couples the AC-powered heating element to alternating current provided by the utility grid and a renewable-AC energy source in a second energy-source mode to heat the water in the storage tank.

Example 7 includes the subject matter of any of Examples 1-6, and wherein the energy-source selector electrically couples the AC-powered heating element to alternating current provided by a renewable-AC energy source in a third energy-source mode to heat the water in the storage tank.

Example 8 includes the subject matter of any of Examples 1-7, and wherein the energy-source selector electrically couples the DC-powered heating element to direct current provided by a renewable-DC energy source in a fourth plurality of energy-source mode to heat the water in the storage tank.

Example 9 includes the subject matter of any of Examples 1-8, and wherein the water reservoir further comprises a temperature sensor configured to detect a temperature of the water in the storage tank, and wherein the energy-source selector is usable to select from three operation modes related to the plurality of energy-source modes.

Example 10 includes the subject matter of any of Examples 1-9, and wherein a first of the three operation modes is configured to heat the water in the storage tank with the AC-powered heating element with alternating current provided by a renewable-AC energy source or the DC-powered heating element with direct current provided by a renewable-DC energy source until a predetermined temperature of the water is met.

Example 11 includes the subject matter of any of Examples 1-10, and wherein a second of the three operation modes is configured to heat the water in the storage tank with the AC-powered heating element with alternating current provided by a utility grid until the predetermined temperature of the water is met, wherein a rate of heating the water in the second operation mode is faster than a rate of heating the water in the first operation mode.

Example 12 includes the subject matter of any of Examples 1-11, and wherein a third of the three operation modes is configured to heat the water in the storage tank with the AC-powered heating element with alternating current provided by the utility grid until a second predetermined temperature of the water is met and then heating the water in the storage tank with the AC-powered heating element with alternating current provided by the renewable-AC energy source or the DC-powered heating element with direct current provided by the renewable-DC energy source until the predetermined temperature of the water is met, wherein the second predetermined temperature of the water is lower than the predetermined temperature of the water.

Example 13 includes a water-heating system comprising a water reservoir including a storage tank adapted to hold water to be heated, a heating unit including an AC-powered heating element arranged to heat water in the storage tank when coupled electrically to an alternating current, a DC-powered heating element arranged to heat water in the storage tank when coupled electrically to a direct current, and a temperature sensor disposed within the storage tank to detect a temperature of the water, an energy-source selector usable by a heating-system operator to select an operation mode configured to control the AC-powered heating element and DC-powered heating element to selectively heat the water in the storage tank to attain a predetermined temperature, and a controller coupled to the heating unit and including a processor and a memory device storing instructions that, when executed by the processor, cause at least one of the AC-powered heating element and the DC-powered heating element to heat the water in the storage tank to a predetermined temperature.

Example 14 includes the subject matter of Example 13, and wherein the operation mode is configured to heat the water in the storage tank with the AC-powered heating element with alternating current provided by a renewable-AC energy source until a predetermined temperature of the water is met.

Example 15 includes the subject matter of any of Examples 13 and 14, and wherein the operation mode is further configured to heat the water with the DC-powered heating element with direct current provided by a renewable-DC energy source until a predetermined temperature of the water is met.

Example 16 includes the subject matter of any of Examples 13-15, and wherein the operation mode is configured heat the water in the storage tank with the AC-powered heating element with alternating current provided by a utility grid until a predetermined temperature of the water is met.

Example 17 includes the subject matter of any of Examples 13-16, and wherein the operation mode is configured to heat the water in the storage tank with the AC-powered heating element with alternating current provided by a utility grid until a second predetermined temperature of the water is met and then heating the water in the storage tank with the AC-powered heating element with alternating current provided by a renewable-AC energy source until a predetermined temperature of the water is met, wherein the second predetermined temperature of the water is lower than the predetermined temperature of the water.

Example 18 includes the subject matter of any of Examples 13-17, and wherein the operation mode is configured to heat the water in the storage tank with the AC-powered heating element with alternating current provided by a utility grid until a second predetermined temperature of the water is met and then heating the water in the storage tank with the DC-powered heating element with direct current provided by a renewable-DC energy source until the predetermined temperature of the water is met, wherein the second predetermined temperature of the water is lower than the predetermined temperature of the water.

Example 19 includes the subject matter of any of Examples 13-18, and wherein the operation mode is further configured to, after the second predetermined temperature of the water is met, heat the water in the storage tank with both the DC-powered heating element with direct current provided by the renewable-direct current energy source and the AC-powered heating element with alternating current provided by a renewable-AC energy source until the predetermined temperature of the water is met.

Example 20 includes the subject matter of any of Examples 13-19, and wherein the renewable-direct current energy source is at least one photovoltaic panel.

Example 21 includes a water-heating system comprising a water reservoir including a storage tank adapted to hold water to be heated, a heating unit including at least one heating element configured to heat water in the storage tank when coupled electrically to at least one of an alternating current, a direct current, or both, a temperature sensor configured to detect a temperature of the water in the storage tank, a controller coupled to the heating unit and including a processor and a memory device storing instructions that, when executed by the processor, causes the at least one heating element to heat the water in the storage tank to at least one predetermined temperature, and means for setting a household profile to cause the controller to operate the water-heating system in accordance with a plurality of parameters set by an user which reflect desired operability of the water-heating system by a household, wherein the controller operates the at least one heating element in accordance with the set household profile.

Example 22 includes the subject matter of Example 21, and wherein the plurality of parameters includes a first pair of predetermined temperatures which has a first upper limit temperature and a first lower limit temperature, and wherein the controller is configured to deactivate the at least one heating element when the temperature sensor detects the temperature of the water to at or above the first upper limit temperature and to activate the at least one heating element when the temperature sensor detects the temperature of the water to be at or below the first lower limit temperature.

Example 23 includes the subject matter of any of Examples 21 and 22, and wherein the at least one heating element is communicable with a renewable-AC energy source, and the plurality of parameters includes a time window having a start time and an end time between which the controller is configured to activate and deactivate the at least one heating element using energy from the renewable-AC energy source in accordance with the first pair of predetermined temperatures.

Example 24 includes the subject matter of any of Examples 21-23, and wherein the at least one heating element is communicable with a utility grid, and the plurality of parameters includes a second pair of predetermined temperatures which has a second upper limit temperature and a second lower limit temperature, and wherein the controller, outside the time window, is configured to activate and deactivate the at least one heating element using energy from the utility grid in accordance with the second pair of predetermined temperatures.

Example 25 includes the subject matter of any of Examples 21-24, and wherein the first upper limit temperature is greater than the second upper limit temperature and the first lower limit temperature is greater than the second lower limit temperature.

Example 26 includes the subject matter of any of Examples 21-25, and wherein the first pair of predetermined temperatures is greater than the second pair of predetermined temperatures.

Example 27 includes the subject matter of any of Examples 21-26, and wherein the at least one heating element is communicable with a renewable-DC energy source.

Example 28 includes the subject matter of any of Examples 21-27, and wherein the at least one heating element includes a first heating element that is communicable with the renewable-DC energy source and a second heating element that is communicable with a renewable-AC energy source or a utility grid.

Example 29 includes the subject matter of any of Examples 21-28, and wherein the plurality of parameters includes a second pair of predetermined temperatures which has a second upper limit temperature and a second lower limit temperature, and wherein the controller is configured to, when the temperature sensor detects the temperature of the water in the storage tank to be at or below the second lower limit temperature, activate both the first heating element and the second heating element, and when the temperature sensor detects the temperature of the water to be at or above the second upper limit temperature, deactivate the second heating element and allow for the first heating element to remain activated until the water is at or above the first upper limit temperature.

Example 30 includes the subject matter of any of Examples 21-29, and wherein the means for establishing a household profile includes a plurality of data outputs that are determined based on the household's use of the water-heating system to determine the efficiency of the water-heating system.

Example 31 includes the subject matter of any of Examples 21-30, and wherein the heating-system operator adjusts one or more of the plurality of parameters based on the plurality of data outputs.

Example 32 includes the subject matter of any of Examples 21-31, and wherein the means for establishing the household profile is a heating-system operator interface.

What is claimed is:

1. A water-heating system comprising:
a water reservoir including a storage tank adapted to hold water to be heated,
a heating unit including at least one heating element configured to heat water in the storage tank when coupled electrically to at least one of an alternating current, a direct current, or both,
a temperature sensor configured to detect a temperature of the water in the storage tank,
a controller coupled to the heating unit and including a processor and a memory device storing instructions that, when executed by the processor, causes the at least one heating element to heat the water in the storage tank to at least one predetermined temperature, and
means for setting a household profile to cause the controller to operate the water-heating system in accordance with a plurality of parameters set by an user which reflect desired operability of the water-heating system by a household,
wherein the controller operates the at least one heating element in accordance with the set household profile.

2. The water-heating system of claim 1, wherein the plurality of parameters includes a first pair of predetermined temperatures which has a first upper limit temperature and a first lower limit temperature, and wherein the controller is configured to deactivate the at least one heating element when the temperature sensor detects the temperature of the water to at or above the first upper limit temperature and to activate the at least one heating element when the temperature sensor detects the temperature of the water to be at or below the first lower limit temperature.

3. The water-heating system of claim 2, wherein the at least one heating element is communicable with a renewable-AC energy source, and the plurality of parameters includes a time window having a start time and an end time between which the controller is configured to activate and deactivate the at least one heating element using energy from the renewable-AC energy source in accordance with the first pair of predetermined temperatures.

4. The water-heating system of claim 3, wherein the at least one heating element is communicable with a utility grid, and the plurality of parameters includes a second pair of predetermined temperatures which has a second upper limit temperature and a second lower limit temperature, and wherein the controller, outside the time window, is configured to activate and deactivate the at least one heating element using energy from the utility grid in accordance with the second pair of predetermined temperatures.

5. The water-heating system of claim 4, wherein the first upper limit temperature is greater than the second upper limit temperature and the first lower limit temperature is greater than the second lower limit temperature.

6. The water-heating system of claim 4, wherein the first pair of predetermined temperatures is greater than the second pair of predetermined temperatures.

7. The water-heating system of claim 2, wherein the at least one heating element is communicable with a renewable-DC energy source.

8. The water-heating system of claim 7, wherein the at least one heating element includes a first heating element that is communicable with the renewable-DC energy source and a second heating element that is communicable with a renewable-AC energy source or a utility grid.

9. The water-heating system of claim 8, wherein the plurality of parameters includes a second pair of predetermined temperatures which has a second upper limit temperature and a second lower limit temperature, and wherein the controller is configured to, when the temperature sensor detects the temperature of the water in the storage tank to be at or below the second lower limit temperature, activate both the first heating element and the second heating element, and when the temperature sensor detects the temperature of the water to be at or above the second upper limit temperature, deactivate the second heating element and allow for the first heating element to remain activated until the water is at or above the first upper limit temperature.

10. The water-heating system of claim 1, wherein the means for establishing a household profile includes a plurality of data outputs that are determined based on the household's use of the water-heating system to determine the efficiency of the water-heating system.

11. The water-heating system of claim 10, wherein the user adjusts one or more of the plurality of parameters based on the plurality of data outputs.

12. The water-heating system of claim 1, wherein the means for establishing the household profile is a user interface.

13. A water-heating system comprising
a water reservoir including a storage tank adapted to hold water to be heated,
an AC-powered heating element arranged to heat water in the storage tank when coupled electrically to an alternating current,
a DC-powered heating element arranged to heat water in the storage tank when coupled electrically to a direct current, and
an energy-source selector configured to control the AC-powered heating element and DC-powered heating element to selectively heat the water in the storage tank to attain a predetermined temperature, the energy-source selector being used to select from among a plurality of energy-source modes to permit heating of the water in the storage tank using a single selected energy source or a combination of selected energy sources.

14. The water-heating system of claim 13, wherein the energy-source selector electrically couples the DC-powered heating element to a renewable-DC energy source in in a first energy-source mode to heat the water in the storage tank.

15. The water-heating system of claim 14, wherein the energy-source selector electrically couples the AC-powered heating element to an alternating current provided by a utility grid in a second energy-source mode to heat water in the storage tank.

16. The water-heating system of claim 15, wherein the energy-source selector electrically couples the AC-powered heating element to an alternating current provided by the utility grid and a renewable-AC energy source in a third energy-source mode.

17. A water-heating system comprising
a water reservoir including a storage tank adapted to hold water to be heated,
a heating unit including an AC-powered heating element arranged to heat water in the storage tank when coupled electrically to an alternating current, a DC-powered heating element arranged to heat water in the storage tank when coupled electrically to a direct current, and a temperature sensor disposed within the storage tank to detect a temperature of the water,
an energy-source selector usable by a user to select an operation mode configured to control the AC-powered heating element and DC-powered heating element to selectively heat the water in the storage tank to attain a predetermined temperature, and
a controller coupled to the heating unit and including a processor and a memory device storing instructions that, when executed by the processor, cause at least one of the AC-powered heating element and the DC-powered heating element to heat the water in the storage tank to a predetermined temperature.

18. The water-heating system of claim 17, wherein the operation mode is configured to heat the water in the storage tank with the AC-powered heating element with alternating current provided by a utility grid until a second predetermined temperature of the water is met and then heating the water in the storage tank with the AC-powered heating element with alternating current provided by a renewable-AC energy source until a predetermined temperature of the water is met, wherein the second predetermined temperature of the water is lower than the predetermined temperature of the water.

19. The water-heating system of claim 17, wherein the operation mode is configured to heat the water in the storage tank with the AC-powered heating element with alternating current provided by a utility grid until a second predetermined temperature of the water is met and then heating the water in the storage tank with the DC-powered heating element with direct current provided by a renewable-DC energy source until the predetermined temperature of the water is met, wherein the second predetermined temperature of the water is lower than the predetermined temperature of the water.

20. The water-heating system of claim 19, wherein the operation mode is further configured to, after the second predetermined temperature of the water is met, heat the water in the storage tank with both the DC-powered heating element with direct current provided by the renewable-direct current energy source and the AC-powered heating element with alternating current provided by a renewable-AC energy source until the predetermined temperature of the water is met.
